(19) United States
(12) Patent Application Publication
(10) Pub. No.: US 2025/0006075 A1
(43) Pub. Date: Jan. 2, 2025

(54) SYSTEM FOR SIMULATING THE OPERATION OF A VEHICLE, ASSOCIATED COMPONENTS, AND METHODS

(71) Applicant: Ahmad Fareed AlDarwish, Dubai (AE)

(72) Inventor: Ahmad Fareed AlDarwish, Dubai (AE)

(21) Appl. No.: 18/710,983

(22) PCT Filed: Nov. 10, 2022
(86) PCT No.: PCT/IB2022/060854

§ 371 Date: May 16, 2024

Related U.S. Application Data
(60) Provisional application No. 63/278,869, filed on Nov. 12, 2021.

(51) Int. Cl. G09B 9/30; G09B 5/06; G09B 9/16; G09B 9/20

(52) U.S. Cl. CPC G09B 9/30; G09B 5/06; G09B 9/16; G09B 9/20

(57) ABSTRACT

A simulation system may include a processor configured to run a simulation including environmental data, operational data, and vehicle data. The system may further include an operator station including an operator input device configured to provide operator input to the processor and a display configured to display the environmental data, the operational data, and the vehicle data. The system may also include an administration station comprising an administration input configured to provide operational data to the processor. The operator station and the administration station may be positioned remotely and may be communicably coupled through a network.

### CROSS REFERENCE TO RELATED APPLICATIONS

This application is a national phase entry under 35 U.S.C. § 371 of International Patent Application PCT/IB2022/060854, filed Nov. 10, 2022, designating the United States of America and published as International Patent Publication WO 2023/084456 A1 on May 19, 2023, which claims the benefit under Article 8 of the Patent Cooperation Treaty to U.S. Patent Application Ser. No. 63/278,869, filed Nov. 12, 2021.

### TECHNICAL FIELD

Embodiments of the present disclosure generally relate to a system for simulating the operation of a vehicle. In particular, embodiments of the present disclosure relate to a system for simulating the operation of a vehicle, and associated components and methods.

### BACKGROUND

Operating a complex vehicle, such as an aircraft, a ship, etc., may include coordinating the efforts of multiple members of a crew or team. Operators of complex vehicles may train on simulators to familiarize themselves with the operating systems, component locations, displays, etc., of the vehicle. Training as a crew may improve efficiency of the crew and reduce mistakes made by different crew members. Even crews having experienced operators at each position may benefit from training together to improve communication between crew members. The crew may train on simulation systems, such as computer generated simulation systems that may include models of a cockpit that provide the crew with a familiarity for the location of different control components of the vehicle.

### BRIEF SUMMARY

Embodiments of the disclosure may include a system for simulating the operation of a vehicle. The system may include a processor configured to run a simulation including environmental data, operational data, and vehicle data. The system may further include an operator station including an operator input device configured to provide operator input to the processor and a display configured to display the environmental data, the operational data, and the vehicle data. The system may also include an administration station comprising an administration input configured to provide operational data to the processor. The operator station and the administration station may be positioned remotely and may be communicably coupled through a network.

Another embodiment of the disclosure may include a method for simulating the operation of a vehicle. The method including displaying simulated operational data of the vehicle through a virtual reality headset. The virtual reality headset displaying a three-dimensional representation of a cockpit of the vehicle and the operational data being displayed in an instrument panel of the three-dimensional representation of the cockpit. The method further including receiving operator input through input devices mounted to a seat in positions approximating a location where the input devices would be mounted in the vehicle. The method also including changing the simulated operational data based on the operator input. The method further including displaying the simulated operational data of the vehicle on a remote administration station. The method also including receiving administrative commands from the remote administration station through a network connection. The method further including changing the simulated operational data based on the administrative commands.

Another embodiment of the disclosure may include an operator station of a simulation system. The operator station may include an operator seat. The operator seat including multiple mounting points for operator input devices in different locations relative to the operator seat. The operator station may further include one or more operator input devices mounted to one or more mounting points of the operator seat in locations representative of a specific vehicle. The one or more operator input devices may be configured to be moved to different mounting points of the operator seat in locations representative of a different vehicle. The operator station may also include a virtual reality display configured to display a graphical representation of the specific vehicle.

### BRIEF DESCRIPTION OF THE DRAWINGS

While the specification concludes with claims particularly pointing out and distinctly claiming embodiments of the present disclosure, the advantages of embodiments of the disclosure may be more readily ascertained from the following description of embodiments of the disclosure when read in conjunction with the accompanying drawings in which:

FIG. 1 illustrates a schematic representation of a simulation system in accordance with embodiments of the disclosure; and

FIG. 2 illustrates a block diagram of a simulation system in accordance with embodiments of the disclosure.

### DETAILED DESCRIPTION

The following description provides specific details, such as material compositions, shapes, and sizes, in order to provide a thorough description of embodiments of the disclosure. However, a person of ordinary skill in the art would understand that the embodiments of the disclosure may be practiced without employing these specific details. Indeed, the embodiments of the disclosure may be practiced in conjunction with conventional techniques employed in the industry.

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the terms “configured” and “configuration” refers to a size, a shape, a material composition, a material distribution, orientation, and arrangement of at least one feature (e.g., one or more of at least one structure, at least one material, at least one region, at least one device) facilitating use of the at least one feature in a pre-determined way.

As used herein, the term “substantially” in reference to a given parameter means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, relational terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the drawings. Unless otherwise specified, the spatially relative terms are intended to encompass different orientations of the elements in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The elements may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, the term “and/or” means and includes any and all combinations of one or more of the associated listed items.

As used herein, the terms “vertical,” “longitudinal,” “horizontal,” and “lateral” are in reference to a major plane of a structure and are not necessarily defined by earth's gravitational field. A “horizontal” or “lateral” direction is a direction that is substantially parallel to the major plane of the structure, while a “vertical” or “longitudinal” direction is a direction that is substantially perpendicular to the major plane of the structure. The major plane of the structure is defined by a surface of the structure having a relatively large area compared to other surfaces of the structure.

Operating a complex vehicle, such as an aircraft, a drone, a ship, etc., may include coordinating the efforts of multiple operators, such as a pilot, co-pilot, crew chief, engineer, first officer, second officer, third officer, etc. The operators may train as a crew to effectively coordinate their efforts. Different crew members may live in different areas distant from one another, which may increase the difficulty of coordinating training with the entire crew in one location. The operators may train on simulation systems, such as computer generated simulations of the operation of a specific vehicle. Simulation systems may include scale models of a cockpit that provide the operator with a familiarity for the locations of different control components of the vehicle. The scale models of the cockpit are large and expensive, often costing millions of dollars to build and operate. Furthermore, when the vehicle changes, such as is updated, newer models arrive, or different models are developed, the scale models of the cockpit may become obsolete as they will no longer match the cockpit of the vehicle. Thus, new expensive and large scale models may need to be created to replicate the newer models. A simulation system with operator stations located remotely and configured to communicate through a network may facilitate training a multi-person crew without having each member of the crew in the same location. However, creating multiple operator stations that are scale models of specific vehicles may be expensive and make it difficult to train on multiple different types of vehicles without having multiple expensive and large simulators at each location.

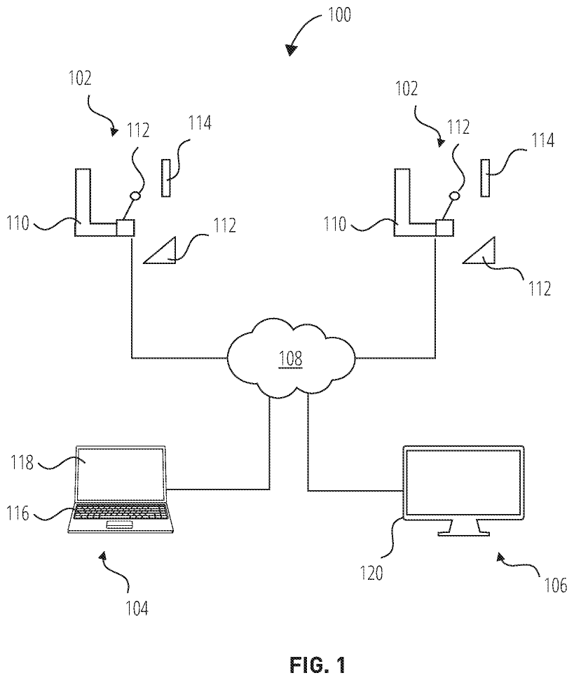

FIG. 1 illustrates a schematic representation of a simulation system 100 for a vehicle, such as an aircraft. The simulation system 100 may include one or more operator stations 102, at least one administrative station 104, as well as optional observation stations 106. Each of the operator stations 102, administrative station 104, and observation stations 106 may be communicatively coupled through a network, such as a local area network (LAN), wireless local area network (WLAN), metropolitan area network (MAN), wide area network (WAN), virtual private network (VPN), etc. The network may allow the operator stations 102, administrative station 104, and/or observation stations 106 to be positioned in locations that are remote from one another, such as different locations in a building, in different cities, or even in different countries. For example, the network may form a metaverse (e.g., virtual reality space) where multiple remotely located operator stations 102, administrative stations 104, observation stations 106 and the associated users may interact as if being positioned in the same location or room.

Each of the operator stations 102 may include a seat 110, operator inputs 112, and a display 114. The seat 110 may provide an anchor point for one or more of the operator inputs 112. The anchor points in the seat 110 may be adjustable, such as to adjust the location of the operator inputs 112 for operators of different sizes. In some embodiments, the seat 110 may be configured to provide multiple different anchor points, such that the seat 110 may be configured to represent different vehicles and/or different positions within the different vehicles. For example, the seat 110 may be configured to adjust positions of the operator inputs 112 to mimic the locations of the operator inputs 112 in different models of aircraft. In some cases, the seat 110 may be configured to position the operator inputs 112 in different positions representative of different seats within the cockpit of a given aircraft. For example, the seat 110 may be configurable to mimic the different positions of the operator inputs 112 and/or different types of operator inputs 112 for the different seats within the cockpit, such as the pilot's seat, the co-pilot's seat, the flight engineer's seat, etc. In some embodiments, the seat 110 may be configured to provide feedback to the operator, such as through vibrations. In some embodiments, the seat 110 may be configured to move to simulate positive, negative, or lateral gravitational forces (e.g., G forces) representative of changes in direction, acceleration, deceleration, etc.

The operator inputs 112 may include various physical controllers present in the type of vehicle being simulated. For example, an aircraft simulation system may include a yoke, side-sticks, thrust levers, pedals, flaps levers, landing gear sticks. The different operator inputs 112 may simulate similar inputs into the simulation system 100 as their counterparts would in the actual vehicle. For example, the thrust levers may provide an input to the simulation system 100 to increase or decrease thrust power. The side-sticks and/or yoke may provide inputs regarding the desired position of the elevators and/or ailerons. The pedals may provide inputs regarding the desired wheel and brake controls and/or yaw control inputs. The flaps lever may provide input regarding the desired flap deployment to change the simulated size and/or shape of the wings. The landing gear sticks may provide input regarding the desired deployment or retraction of the landing gear. The different operator inputs 112 may be provided to the simulation model described in further detail below. The simulation model may adjust operational parameters provided to a physics model of the vehicle based on the inputs received from the operator inputs 112. For example, an aircraft with landing gear deployed behaves differently from an aircraft with retracted landing gear. Similarly different wing shapes due to flap orientation behave differently.

The display 114 may provide the operator with a simulated view of the cockpit and additional controls therein. In some cases, the display 114 may be a virtual reality display, such as a virtual reality headset or virtual reality glasses. The display 114 may receive input from the operator inputs 112 such that the position of the respective devices in the display 114 reflect the positions provided by the operator through the operator inputs 112. In some embodiments, additional inputs, such as buttons, switches, etc., may be provided to the operator through the display 114. For example, the operator may have an additional input controller attached to their hand to indicate to the display 114 and/or simulation system 100 the operator hand position, such that the operator may interact with the additional inputs through the display. The additional input controller may be gloves worn by the operator configured to provide relative positions of the operator's hands and/or fingers to the display 114 and/or simulation system 100.

The display 114 may be configured to follow the motion of the operator's head, such as through accelerometers in the display 114, such that the simulated view provided to the operator changes when the operator is looking in different directions. For example, the display 114 may display different regions of control panels from the cockpit, different informational displays, views through windows of the vehicle, and/or other areas of the cockpit based on the direction that the operator is looking.

As illustrated in FIG. 1, the simulation system 100 may include multiple different operator stations 102. The different operator stations 102 may be positioned remote from one another. Each of the operator stations 102 may communicate with the simulation system 100 through the network 108 as described above. The multiple different operator stations 102 may allow multiple crew members to interact with the simulation system 100 simultaneously, such that the crew members may act as a crew in the simulation. The network 108 connection may provide audio communication at least between the operator stations 102, such that the operators at each of the operator stations 102 may communicate with each other throughout the simulation. As described above, the operator stations 102 may be configurable to represent different positions within the cockpit. Thus, the crew members may each complete their respective tasks throughout the simulation in real time as if sitting in the same cockpit without being in the same location.

The administrative station 104 may include an administrator input 116 and a display 118. The administrative station 104 may be a computer, such as a personal computer (PC), laptop computer, tablet computer, etc. The administrator input 116 may allow an administrator to start a simulation, stop a simulation, re-start a simulation, etc. In some embodiments, the administrator input 116 may allow an administrator to input errors into the simulation, such as a simulated mechanical failure, a simulated electrical failure, a simulated sensor failure, etc., for testing a crew's response to failures and other associated errors while operating the vehicle. In some cases, the administrator may stop a simulation and re-start the simulation at a specific checkpoint. For example, a catastrophic error by the crew may result in the simulation stopping and the administrator may return the simulation to a point before the error was made by the crew so that they may correct the error in the simulation. In other cases, a specific maneuver may need to be practiced by the crew, such that the administrator may stop the simulation after the maneuver is completed and re-start the simulation at a point prior to the maneuver, such that the crew may practice the maneuver multiple times without going through an entire simulated flight.

The display 118 of the administrative station 104 may provide a display of what the operators are seeing, the control panel or instrument panel of the vehicle, operational data for the simulation, etc. In some embodiments, the display 118 may be configured to selectively switch between the different views. For example, the administrator may switch the display between a view of the control panel of the vehicle, operational data for the simulation, or a mirror of the operator's display 114. The display 118 may also include operational information and an operations interface that may allow the administrator to input view and/or change operational data, such as weather conditions, mechanical system failures, sensor failures, electrical failures, etc. The display 118 may also include a map or other image configured to display the progress of the simulated path through the simulation and allow the administrator to change the path and/or where the vehicle is positioned along the path (e.g., to restart the simulation at a desired location as described above).

The observation station 106 may include a display 120 configured to display one or more of the views of the control panel of the vehicle, the operational data for the simulation, and/or a mirror of the operator's display 114. For example, the display 120 may include a large screen displaying multiple different views through a split screen. In some embodiments, the observer may be able to select the view that is displayed on the display 120. In other embodiments, the administrator may control the view that is displayed on the display 120 of the observation station 106 through the administrative station 104. Unlike the administrative station 104, the observation station 106 may not provide any inputs into the simulation system 100. Rather, the observation station 106 may be configured to allow an observer to monitor the progress of the operators in the simulation.

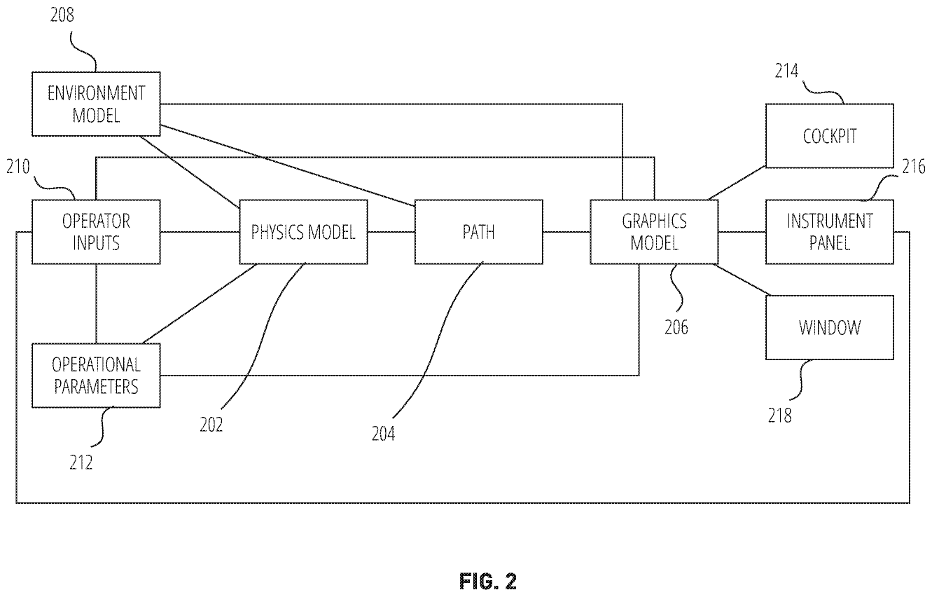

FIG. 2 illustrates a block diagram representative of the simulation. As described above, the simulation may be configured to simulate the operation of a vehicle, such as an aircraft. The simulation may include a physics model 202 and a graphics model 206. The physics model 202 may be configured to model the behavior of the vehicle. For example, the physics model 202 may include a general shape of the vehicle. The physics model 202 may receive inputs from an environment model 208, operator inputs 210, and operational parameters 212. In some embodiments, the physics model 202 and the graphics model 206 may operate on the same computing device, such as a personal computer, laptop computer, tablet computer, server computer (e.g., cloud computer), etc. For example, the simulation may be created and/or run from a server computer on the network 108 (FIG. 1). The server computer may receive inputs from the operator stations 102 and the administrative station 104 and operate/change the simulation based on the inputs received from the operator stations 102 and/or the administrative station 104. In another example, the administrative station 104 may be configured to run the simulation, such that the administrative station 104 receives inputs from the operator stations 102 and the administrator input 116 and operates/changes the simulation based on the inputs.

The environment model 208 may provide environmental conditions information, such as temperature, air density, moisture content, pressure, weather data, etc. The operational parameters 212 may provide information about the vehicle (e.g., vehicle shape, vehicle size, vehicle weight, etc.) and information about the components of the vehicle (e.g., wing flap positions, rudder position, aileron position, elevator position, thrust force, landing gear position, component failures, etc.). In some cases, the operational parameters 212 may be pre-programmed elements, such as vehicle shape and size. In some cases, the operational parameters 212 may change based on the simulation. For example, the vehicle weight may reduce throughout the simulation to simulate fuel being used. The shape of the vehicle may change based on operator inputs, such as deploying landing gear, deploying flaps, adjusting a position of the elevator or ailerons. A thrust force may change based on user inputs.

The operator inputs 210 may be provided by the operator inputs 112 of the one or more operator stations 102 through the network 108 (FIG. 1). The operator inputs 210 may provide inputs to the physics model 202 directly, such as providing changes to thrust, rudder position, aileron position, elevator position, wing flaps, landing gear, etc. In some cases, the operator inputs 210 may provide input to the physics model 202 through the operational parameters 212, such as by changing the wing flap positions, rudder position, aileron positions, elevator position, thrust force, landing gear position, etc., provided to the physics model 202 by the operational parameters 212.

The physics model 202 may combine the vehicle information, component information, and environmental conditions information to calculate vehicle movement data, such as airspeed, yaw rate, pitch angle, roll angle, velocity directions, acceleration directions, etc. For example, the physics model 202 may determine airflow over the vehicle (e.g., over the wings, the tail, the flaps, the ailerons, the elevators, etc.), pressure differences generated by the airflow (e.g., lift, drag, etc.), friction forces (e.g., drag), thrust forces, component forces (e.g., wing forces, joint forces, etc.), moments of the forces (e.g., torque, rotational force), etc. The physics model 202 may then determine the vehicle movement data based on the pressure differences, forces, moments, and airflow.

The vehicle movement data from the physics model 202 may determine the path 204 that the vehicle follows in the simulation. The path 204 may feed back into the environment model 208. For example, the environment model 208 may provide changing environmental conditions based on a location of the vehicle in the simulation. The operator may be provided with a predetermined path to follow, such as a flight path. The environment model 208 may provide changing conditions along the predetermined path. The environment model 208 may also extend a distance, such as in a range from about 1 mile to about 100 miles (1.60935 kilometers to 160.935 kilometers) about beyond the predetermined path, such that the operator may correct a course of the vehicle in the simulation before exiting the area defined by the environment model 208. In some embodiments, the environment model 208 may define a known path, such as a common flight path between two locations (e.g., airports, landmarks, etc.). The environment model 208 may include fixed obstacles, such as mountain ranges, large buildings, etc., as well as moving obstacles, such as storms, traffic, etc.

The path 204 may define specific points within the environment model 208 where the vehicle is expected to pass within the simulation. For example, the points may include a start point (e.g., an airport or terminal within the airport), an end point (e.g., a second airport or terminal within the second airport), and multiple checkpoints along the projected vehicle path. The points may provide starting and/or stopping points for the simulation. For example, if the path 204 followed by the vehicle in the simulation goes of course, such as leaving the area defined by the environment model 208, the administrator may re-start the simulation with the vehicle positioned at the most recent checkpoint that was passed by the vehicle. Similarly, a mistake by the operator that results in a crash or other catastrophic failure may cause the simulation to restart with the vehicle positioned at the most recent check point. As described above, the checkpoints may also be used by the administrator to have the operator(s) practice a specific section of the simulated flight, such as a specific maneuver (e.g., taking off, landing, etc.), without going through an entire simulated flight.

The graphics model 206 may receive input from the environment model 208, the operator inputs 210, the operational parameters 212, and the path 204 to generate interactive graphics. The graphics may provide a three-dimensional representation of the area surrounding the operator. The graphics model 206 may generate cockpit graphics 214, instrument panel graphics 216, and window graphics 218. While the graphics may represent an area substantially surrounding the operator, the portions of the graphics displayed to the operator may be based on the direction that the user is facing. As described above, the display 114 of the operator station 102 may be a virtual reality (VR) headset. The VR headset may provide the simulation system 100 with position information regarding the position of the operator's head. Thus, the display 114 may display the portion of the graphics model 206 that would be in front of the operator in the direction that the operator is facing while the portion of the graphics model 206 that is behind the operator is not displayed until the operator turns toward it. For example, if the operator is looking at the instrument panel, the display 114 may display the instrument panel and any area immediately surrounding the instrument panel, while the display 114 may not display other members of the crew and their locations that are not near the instrument panel.

The cockpit graphics 214 may include the general layout of the cockpit of the vehicle, such as the operator console including instrument panels, gauges, dials, screens, digital displays, heads-up displays (HUD), levers, side-sticks, pedals, joy-sticks, yokes, windows, and locations of other members of the crew. The cockpit graphics 214 may also include a graphical representation of the operator from a first person point of view, such as views of the operator's arms, hands, legs, etc. The cockpit graphics 214 may also include graphical representations of the other members of the crew in their respective positions within the cockpit. In some embodiments, the positions of the operator's hands and arms may be determined based on operator inputs 210, such as which operator input device changed most recently. In some embodiments, the operator may wear or hold a device configured to provide a location of the operator's hand to the simulation system 100, such as gloves with position and/or acceleration sensors.

The instrument panel graphics 216 may include gauges or indicators representative of information that would be displayed in the vehicle, such as airspeed, altitude, vertical speed, horizontal situation, pitch angle, roll angle, yaw rate, etc. The gauges and/or indicators may be positioned in similar positions to the vehicle being simulated, such that the operators may become familiar with the locations of each different gauge or indicator. The instrument panel graphics 216 may also include lights, such as indicator lights, alarm lights, fault lights, etc. The instrument panel graphics 216 may further include operator input elements such as switches, dials, or buttons. In some cases, the simulation system 100 may be configured to allow the operator to interact with the switches, dials, or buttons, such as through a virtual reality (VR) interface. For example, as described above the operator may wear or hold a device configured to provide a location of the operator's hand to the simulation system 100. The operator's hand position may be determined with respect to the switches, dials, or buttons, such that the operator may toggle switches, push buttons, and move dials virtually through the VR interface.

The window graphics 218 may include a view of the surrounding environment through the windows of the vehicle, such as the ground, the horizon, clouds, etc. The detail of the surrounding environment may change based on a location of the vehicle in the simulation. For example, the detail may be greater when an aircraft is approaching an airport, taking off from the airport, and/or navigating the airport. When the aircraft is flying at a cruising altitude, the detail may be reduced, such that the window graphics 218 include a horizon line, with minimal detail of the ground. The window graphics 218 may receive additional input from the environment model 208, such as the proximity of storms or other obstacles, such that the obstacles may be represented as the vehicle approaches them in the simulation to provide the operator with the opportunity to take the necessary action to address the obstacles.

As indicated above, the operational parameters 212 may include component failures. Component failures may include mechanical failures, such as flaps that do not move correctly, landing gear that does not lock in or does not retract, etc., or electrical failures, such as sensor failures, controller failures, etc. The component failures may trigger alarm or fault lamps in the instrument panel graphics 216 of the graphics model 206. The component failures may also affect the physics model 202 and/or the vehicle movement data calculated by the physics model 202. The component failures may test the operator's ability to address a component failure within the simulation, such as troubleshooting the component failure, bypassing the component, fixing the component failure, compensating for the component failure, etc.

The graphics model 206 may also generate audio signals to the operator. For example, alarms may be generated to coincide with the illumination of alarm and/or fault lamps in the instrument panel graphics 216. In some embodiments, the graphics model 206 may generate sounds to replicate noise within the cockpit of the vehicle, such as wind noise, engine noise, etc. The noises may be configured to resemble different situations. For example, the engine noise may increase if thrust is increased, wind noise may increase when drag increases, such as when landing gear and/or flaps are deployed, etc.

Non-limiting example embodiments of the disclosure include:

Embodiment 1: A system for simulating operation of a vehicle, the system comprising: a processor configured to run a simulation including environmental data, operational data, and vehicle data; an operator station comprising: an operator input device configured to provide operator input to the processor; and a display configured to display the environmental data, the operational data, and the vehicle data; and an administration station comprising an administration input configured to provide the operational data to the processor; wherein the operator station and the administration station are positioned remotely and are communicably coupled through a network.

Embodiment 2: The system of embodiment 1, wherein the display of the operator station is configured to display the environmental data, the operational data, and the vehicle data through instrument panels resembling a cockpit of the vehicle.

Embodiment 3: The system of embodiment 1 or embodiment 2, further comprising a second operator station located remotely from both the operator station and the administration station, wherein the second operator station is communicably coupled to both the operator station and the administration station through the network.

Embodiment 4: The system of embodiment 3, further comprising an audio connection between the operator station and the second operator station configured to provide audio communication between a first operator at the operator station and a second operator at the second operator station.

Embodiment 5: The system of embodiment 4, wherein the audio connection passes through the network.

Embodiment 6: The system of any one of embodiments 1 through 5, wherein the processor is located in the administration station.

Embodiment 7: The system of any one of embodiments 1 through 6, wherein the processor is located remotely from the administration station and is communicably coupled to the administration station through the network.

Embodiment 8: A method for simulating operation of a vehicle, the method comprising: displaying simulated operational data of the vehicle through a virtual reality headset, the virtual reality headset displaying a three-dimensional representation of a cockpit of the vehicle and the operational data is displayed in an instrument panel of the three-dimensional representation of the cockpit; receiving operator input through input devices mounted to a seat in positions approximating a location where the input devices would be mounted in the vehicle; changing the simulated operational data based on the operator input; displaying the simulated operational data of the vehicle on a remote administration station; receiving administrative commands from the remote administration station through a network connection; changing the simulated operational data based on the administrative commands.

Embodiment 9: The method of embodiment 8, further comprising displaying operational data of the vehicle on an observation station.

Embodiment 10: The method of embodiment 8 or embodiment 9, wherein displaying simulated operational data comprises simulating operational data through a physics model of the vehicle.

Embodiment 11: The method of embodiment 10, wherein simulating the operational data through the physics model of the vehicle comprises inputting operational parameters and environmental parameters and simulating the operational data based on the operational parameters and the environmental parameters.

Embodiment 12: The method of embodiment 11, wherein inputting the environmental parameters comprises inputting at least one of a temperature, an air density, a moisture content, a pressure, and weather data.

Embodiment 13: The method of embodiment 11 or embodiment 12, wherein inputting the operational parameters comprises inputting at least one of a wing flap position, a rudder position, an aileron position, an elevator position, a thrust force, a landing gear position, and a component failure.

Embodiment 14: The method of any one of embodiments 11 through 13, wherein changing the simulated operational data comprises changing at least one of the operational parameters and the environmental parameters.

Embodiment 15: An operator station of a simulation system, the operator station comprising: an operator seat, the operator seat including multiple mounting points for operator input devices in different locations relative to the operator seat; one or more operator input devices mounted to one or more mounting points of the operator seat in locations representative of a specific vehicle, wherein the one or more operator input devices are configured to be moved to different mounting points of the operator seat in locations representative of a different vehicle; and a virtual reality display configured to display a graphical representation of the specific vehicle.

Embodiment 16: The operator station of embodiment 15, further comprising an operator hand position input configured to provide a relative position of an operator's hand to the virtual reality display.

Embodiment 17: The operator station of embodiment 15 or embodiment 16, further comprising a headset including the virtual reality display.

Embodiment 18: The operator station of embodiment 17, wherein the headset includes one or more sensors configured to detect a position of an operator's head.

Embodiment 19: The operator station of embodiment 18, wherein the virtual reality display is configured to change based on the position of the operator's head.

Embodiment 20: The operator station of any one of embodiments 15 through 19, wherein the one or more operator input devices include one or more of a yoke, a side-stick, a thrust lever, a pedal, a flaps lever, and a landing gear stick.

Thus, embodiments of the disclosure may allow different members of a crew to simulate the operation of a vehicle in real time from different locations. Virtual reality technology and a seat with configurable operator input locations may reduce the cost of creating the simulation at multiple locations by providing the look and feel of a specific type of vehicle without a full scale model of the portion of the vehicle being created. The ability to provide the look and feel of a specific type of vehicle without a full scale model may allow a single simulation station to simulate multiple different vehicles (e.g., models, types, etc.) by changing minor configurations of the simulation station. Decreasing costs and allowing crew members to train from remote locations may increase the amount of team training and simulated vehicle operation time with a complete crew. Increasing the amount of training for crews may reduce the number of mistakes and improve quality of crew communication during operation of the vehicle.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the present disclosure, in addition to those shown and described herein, such as alternative useful combinations of the elements described, may become apparent to those skilled in the art from the description. Such modifications and embodiments are also intended to fall within the scope of the appended claims and their legal equivalents.

1. A system for simulating operation of a vehicle, the system comprising:
a processor configured to run a simulation including environmental data, operational data, and vehicle data;
an operator station comprising:
an operator input device configured to provide operator input to the processor; and
a display configured to display the environmental data, the operational data, and the vehicle data; and
an administration station comprising an administration input configured to provide the operational data to the processor;
wherein the operator station and the administration station are positioned remotely and are communicably coupled through a network.

2. The system of claim 1, wherein the display of the operator station is configured to display the environmental data, the operational data, and the vehicle data through instrument panels resembling a cockpit of the vehicle.

3. The system of claim 1, further comprising a second operator station located remotely from both the operator station and the administration station, wherein the second operator station is communicably coupled to both the operator station and the administration station through the network.

4. The system of claim 3, further comprising an audio connection between the operator station and the second operator station configured to provide audio communication between a first operator at the operator station and a second operator at the second operator station.

5. The system of claim 4, wherein the audio connection passes through the network.

6. The system of claim 1, wherein the processor is located in the administration station.

7. The system of claim 1, wherein the processor is located remotely from the administration station and is communicably coupled to the administration station through the network.

8. A method for simulating operation of a vehicle, the method comprising:
displaying simulated operational data of the vehicle through a virtual reality headset, the virtual reality headset displaying a three-dimensional representation of a cockpit of the vehicle and the operational data is displayed in an instrument panel of the three-dimensional representation of the cockpit;
receiving operator input through input devices mounted to a seat in positions approximating a location where the input devices would be mounted in the vehicle;
changing the simulated operational data based on the operator input;
displaying the simulated operational data of the vehicle on a remote administration station;
receiving administrative commands from the remote administration station through a network connection; and
changing the simulated operational data based on the administrative commands.

9. The method of claim 8, further comprising displaying operational data of the vehicle on an observation station.

10. The method of claim 8, wherein displaying simulated operational data comprises simulating operational data through a physics model of the vehicle.

11. The method of claim 10, wherein simulating the operational data through the physics model of the vehicle comprises inputting operational parameters and environmental parameters and simulating the operational data based on the operational parameters and the environmental parameters.

12. The method of claim 11, wherein inputting the environmental parameters comprises inputting at least one of a temperature, an air density, a moisture content, a pressure, and weather data.

13. The method of claim 11, wherein inputting the operational parameters comprises inputting at least one of a wing flap position, a rudder position, an aileron position, an elevator position, a thrust force, a landing gear position, and a component failure.

14. The method of claim 11, wherein changing the simulated operational data comprises changing at least one of the operational parameters and the environmental parameters.

15. An operator station of a simulation system, the operator station comprising:
an operator seat, the operator seat including multiple mounting points for operator input devices in different locations relative to the operator seat;
one or more operator input devices mounted to one or more mounting points of the operator seat in locations representative of a specific vehicle, wherein the one or more operator input devices are configured to be moved to different mounting points of the operator seat in locations representative of a different vehicle; and
a virtual reality display configured to display a graphical representation of the specific vehicle.

16. The operator station of claim 15, further comprising an operator hand position input configured to provide a relative position of an operator's hand to the virtual reality display.

17. The operator station of claim 15, further comprising a headset including the virtual reality display.

18. The operator station of claim 17, wherein the headset includes one or more sensors configured to detect a position of an operator's head.

19. The operator station of claim 18, wherein the virtual reality display is configured to change based on the position of the operator's head.

20. The operator station of claim 15, wherein the one or more operator input devices include one or more of a yoke, a side-stick, a thrust lever, a pedal, a flaps lever, and a landing gear stick.
